(19) United States
(12) Patent Application Publication
(10) Pub. No.: US 2006/0161911 A1
(43) Pub. Date: Jul. 20, 2006

(54) Method and apparatus for managing versioning data in a network data processing system

(76) Inventors: John William Barrs, Austin, TX (US); Michael Wayne Brown, Georgetown, TX (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(21) Appl. No.: 11/037,001

(22) Filed: Jan. 18, 2005

(51) Int. Cl. G06F 9/44

(52) U.S. Cl. 717/170

(57) ABSTRACT

A method, apparatus, and computer instructions for managing versioning data for a state between a first virtual machine on a data processing system and a second virtual machine on a remote data processing system. Versioning information is stored in response to a request to generate a version in the first virtual machine. A request is sent to the second virtual machine for the second virtual machine to generate a corresponding version. The version and the corresponding version are used to restore the first virtual machine and the second virtual machine to the prior state. The prior state in the first virtual machine is restored using the stored version when a subsequent request is received to restore the prior state. A subsequent request is sent to the second virtual machine. This request requests restoring the prior state for the second virtual machine using the corresponding version.

### CROSS REFERENCE TO RELATED APPLICATIONS

The present invention is related to the following patent applications: entitled “Method and Apparatus for Dimensional Data Versioning and Recovery Management”, Ser. No. ______, attorney docket no. AUS920040309US1; entitled “Method and Apparatus for Data Versioning and Recovery Using Delta Content Save and Restore Management”, Ser. No. ______, attorney docket no. AUS920040638US1; entitled “Platform Infrastructure to Provide an Operating System Based Application Programming Interface Undo Service”, Ser. No. ______, attorney docket no. AUS920040639US1; entitled “Virtual Memory Management Infrastructure for Monitoring Deltas and Supporting Undo Versioning in a Paged Memory System”, Ser. No. ______, attorney docket no. AUS920040640US1; entitled “Infrastructure for Device Driver to Monitor and Trigger Versioning for Resources”, Ser. No. ______, attorney docket no. AUS920040641US1; entitled “Heap Manager and Application Programming Interface Support for Managing Versions of Objects”, Ser. No. ______, attorney docket no. AUS920040643US1; entitled “Method and Apparatus for Marking Code for Data Versioning”, Ser. No. ______, attorney docket no. AUS920040644US1; and entitled “Object Based Access Application Programming Interface for Data Versioning”, Ser. No. ______, attorney docket no. AUS920040645US1 filed even date hereof, assigned to the same assignee, and incorporated herein by reference.

### BACKGROUND OF THE INVENTION

1. Technical Field

The present invention relates generally to an improved data processing system and in particular, to a method, apparatus, and computer instructions for processing data. Still more particularly, the present invention relates to a method, apparatus, and computer instructions for managing versioning data in a network.

2. Description of Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized both communications and commerce, as well as, being a source of both information and entertainment. For many users, email is a widely used format to communicate over the Internet. Additionally, the Internet also is used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transactions using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML are also referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for selection of various functions through menus and allows for navigation. For example, a menu may allow a user to perform various functions, such as saving a file, opening a new window, displaying a history, and entering a URL.

A user through a browser or other client application may access data and other information through applications on remote data processing systems. For example, a user may employ a browser to access a website to purchase goods or services. In purchasing goods or services, the user may place items in a “shopping cart”. A shopping cart is a piece of software that acts as an online store's catalog and ordering process. Typically, a shopping cart is the interface between a company's Website and its deeper infrastructure, allowing consumers to select merchandise; review what they have selected; make necessary modifications or additions; and purchase the merchandise.

After a purchase has been made, the transaction is considered completed, and the user is unable to undo the purchase. If the user wishes to cancel an order for goods or services, the user is required to call or send an e-mail message to the company, requesting cancellation of the purchase. Such a process is tedious and often frustrating for the user. Therefore, it would be advantageous to have an improved method, apparatus, and computer instructions for restoring the state of a transaction to a prior state.

### SUMMARY OF THE INVENTION

The present invention provides a method, apparatus, and computer instructions for managing versioning data for a state between a first virtual machine on a data processing system and a second virtual machine on a remote data processing system. Versioning information is stored in response to a request to generate a version in the first virtual machine. A request is sent to the second virtual machine for the second virtual machine to generate a corresponding version. The version and the corresponding version are used to restore the first virtual machine and the second virtual machine to the prior state. The prior state in the first virtual machine is restored using the stored version when a subsequent request is received to restore the prior state. A subsequent request is sent to the second virtual machine. This request requests restoring the prior state for the second virtual machine using the corresponding version.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in managing and restoring data between two Java virtual machines in accordance with a preferred embodiment of the present invention;

FIG. 5 is a diagram illustrating components used in a versioning system in accordance with a preferred embodiment of the present invention;

FIG. 6 is a diagram illustrating components used to provide an undo service in accordance with a preferred embodiment of the present invention;

FIG. 7 is a diagram illustrating a device driver used to save state information in accordance with a preferred embodiment of the present invention;

FIG. 8 is a diagram illustrating a virtual memory manager used to save state information in accordance with a preferred embodiment of the present invention;

FIG. 9 is a diagram illustrating components used in data versioning and recovery in accordance with a preferred embodiment of the present invention;

FIG. 10 is a diagram illustrating components used in providing data versioning and recovery management in accordance with a preferred embodiment of the present invention;

FIG. 11 is a diagram illustrating a delta object linked list in accordance with a preferred embodiment of the present invention;

FIG. 12 is a diagram of a delta object linked list in accordance with a preferred embodiment of the present invention;

FIG. 13 is a flowchart of a process for storing a version of data in accordance with a preferred embodiment of the present invention;

FIG. 14 is a flowchart of a process for restoring a prior version of data in accordance with a preferred embodiment of the present invention;

FIG. 15 is a flowchart of a process in a device driver for saving state information in accordance with a preferred embodiment of the present invention;

FIG. 16 is a flowchart of a process in a device driver for saving state information in accordance with a preferred embodiment of the present invention;

FIG. 17 is a flowchart of a process in a device driver for saving state information in accordance with a preferred embodiment of the present invention;

FIG. 18 is a flowchart of a process in a device driver for restoring state information in accordance with a preferred embodiment of the present invention;

FIG. 19 is a flowchart of a process in a virtual memory manager for storing versions of pages in accordance with a preferred embodiment of the present invention;

FIG. 20 is a flowchart of a process in a virtual memory manager for retrieving pages from a swap file in accordance with a preferred embodiment of the present invention;

FIG. 21 is a flowchart of a process for allocating objects in accordance with a preferred embodiment of the present invention;

FIG. 22 is a flowchart of a process for storing delta data in accordance with a preferred embodiment of the present invention;

FIG. 23 is a flowchart of a process for returning an object to an earlier state in accordance with a preferred embodiment of the present invention;

FIG. 24 is a flowchart of a process for restoring an object to an earlier state in accordance with a preferred embodiment of the present invention;

FIG. 25 is a flowchart of creating a version of data on a remote data processing system in accordance with a preferred embodiment of the present invention;

FIG. 26 is a flowchart of a process for restoring data to a prior state in accordance with a preferred embodiment of the present invention; and

FIG. 27 is a flowchart of a process to restore data to a prior version in accordance with a preferred embodiment of the present invention.

### DETAILED DESCRIPTION OF THE PREFERRED EMBODIMENT

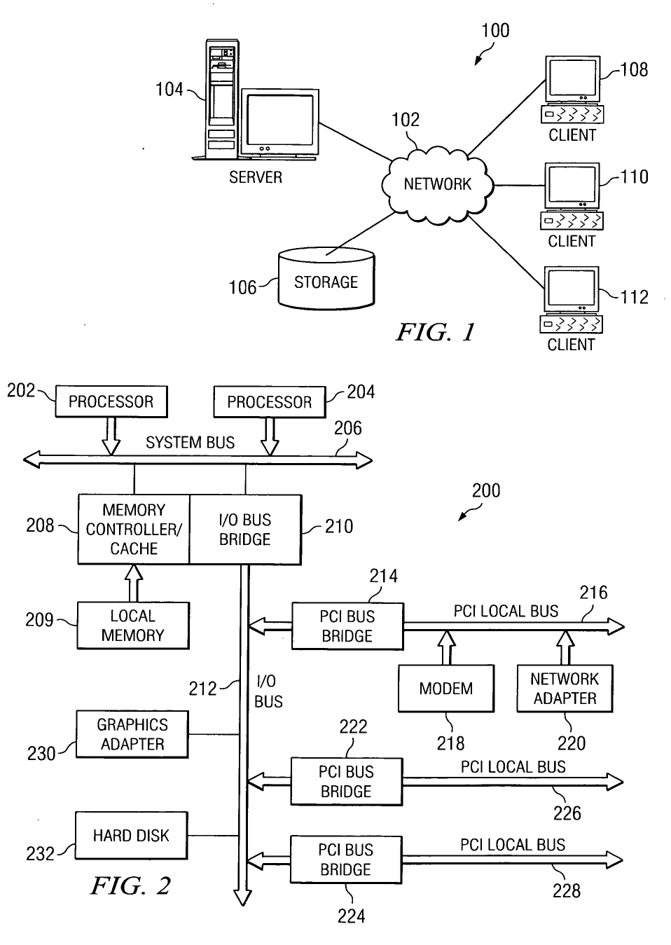

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

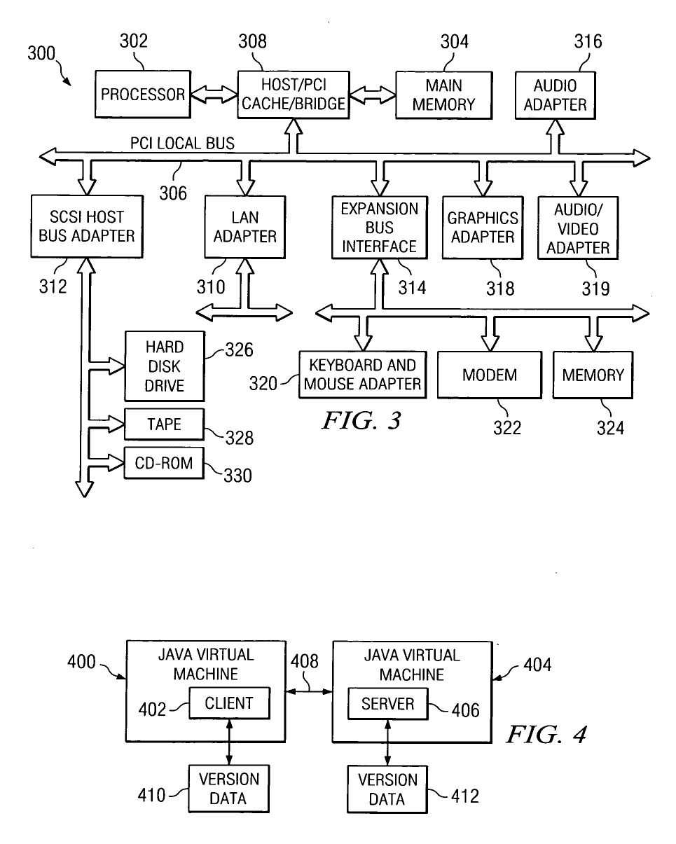

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for managing versioning information between two virtual machines. In particular the illustrative examples depict the management of versioning information between virtual machines in the form of Java virtual machines. The mechanism of the present invention stores information needed to restore both Java virtual machines to the same state. This mechanism also provides for restoring the two Java virtual machines to the prior state. The mechanism implements an application programming interface for initiating the saving of information and for restoring the information for different states. This mechanism may be applied to other components in the data processing system in addition to the Java virtual machines and may include granularity such that particular objects are saved.

Turning next to FIG. 4, a diagram illustrating components used in managing and restoring data between two Java virtual machines is depicted in accordance with a preferred embodiment of the present invention. In this example, Java virtual machine 400 is located in one data processing system, such as client 112 in FIG. 1, and contains client 402, which is a client application. Java virtual machine 404 is located in another data processing system such as server 104 in FIG. 1. This Java virtual machine contains server 406, which is a server application in this example.

Java virtual machine 400 and Java virtual machine 404 communicate with each other through communications link 408. In these examples, a session is present between client 402 and server 406. As used herein, a session is an active connection between two computers. In these examples, client 402 may cause Java virtual machine 400 and Java virtual machine 404 to save versions of data, such as version data 410 and version data 412. Version data 410 is considered one version for the version of data in the data processing system on which Java virtual machine 400 is located, while version data 412 is considered a corresponding version for the version of data in the remote data processing system in which Java virtual machine 404 is located. These two versions are associated with a version identifier in these examples. Version data 410 contains the data needed to restore the session from client 402's perspective to a prior state. Version data 412 contains the information needed to restore the session from server 406's perspective to a prior state.

For example, if a user in a browser application wishes to save a particular part of a session, the user may initiate a request through the browser application to save a version of data for the session. This request is received by Java virtual machine 400 in the form of an application programming interface (API) call. An API is a language and message format used by an application program to communicate with the operating system. APIs are implemented by writing function calls in the program, which provide the linkage to the required subroutine for execution.

As a result, information needed to restore this session to this particular point is stored as version data 410. This information includes data, such as, for example, objects created for the session by Java virtual machine 400, information on hardware states, and any other information needed to restore the session to this state. One example of information stored is the connection information for communications link 408. This connection information includes, for example, the connection speed and the identity of the server 406. As another example, information on hardware states may include a particular state of a printer, such as a printer in a PCL print mode.

Additionally, in response to receiving this call, Java virtual machine 400 also issues a call or request to Java virtual machine 404 across communications link 408 to save information for the session. Java virtual machine 404 selectively processes this request. Depending on the policy or rules set for Java virtual machine 404, the request may be ignored. In some cases, it is undesirable to allow Java virtual machine 404 to save the data needed to restore a session to a prior version. Whether a request is processed may depend on various factors, such as, for example, the identity of the client, the type of session, or the type of application being used. For example, a user may be allowed to store a version of data for a session at a point in time prior to a transaction such as a purchase of an item.

If information for the session is to be saved, Java virtual machine 404 saves all of the data needed to store the session from the perspective of Java virtual machine 404. This information is saved as version data 412.

At a later point in time, a request may be made to restore a session between client 404 and server 406 to a prior version or state. At this time, Java virtual machine 400 uses version data 410 to restore the session to the prior version. Additionally, a call or request is made by Java virtual machine 400 to Java virtual machine 404 to restore the session to the prior version from the standpoint of server 406. Java virtual machine 404 selectively restores the session. In some cases, a client may not be allowed to restore a session to a prior version. For example, in a sale of goods through a Website a client may not be able to cancel a transaction through this mechanism if the item is a sale item, while a transaction for other items not on sale may be cancelled by restoring the session to a prior version.

Although a client/server relation is shown, this mechanism may also be applied to any exchange of information between any two Java virtual machines. For example, applications using a peer-to-peer connection or an application accessing a Java service also may implement the mechanism of the present invention. Additionally, depending on the particular implementation, all of the data needed to restore a session may be stored by a single Java virtual machine. Additionally, server 406 may initiate the storing of versions and the restoring of these versions. The mechanism also may be implemented in other virtual machines.

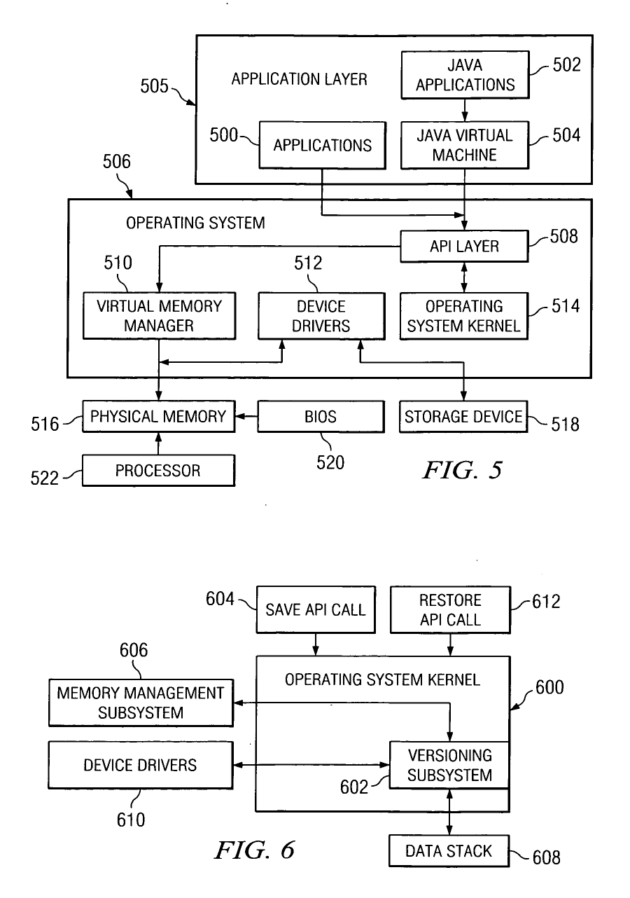

In this example, the session information between the two virtual machines is for the sale of goods. The mechanism of the present invention may be applied to other types of distributed transactions in which dependency is present between state information in the two virtual machines. With reference to FIG. 5, a diagram illustrating components used in a versioning system is depicted in accordance with a preferred embodiment of the present invention. These components are examples of components that may be found in a data processing system, such as data processing system 200 in FIG. 2.

In this example, applications 500, Java applications 502, and Java virtual machine 504 are located in an application layer 505. Applications 500, and Java virtual machine 504 may send requests or calls to operating system 506. These calls are handled through API layer 508 within operating system 506.

Java applications 502 make calls to Java virtual machine 504. A Java virtual machine is a Java interpreter. The Java virtual machine is software that converts the Java intermediate language, such as bytecodes, into machine language and executes the machine's language. A Java virtual machine is typically incorporated into a Web browser to execute Java applets. A Java virtual machine also is installed in a Web server to execute server-side Java programs. A Java virtual machine also can be installed in a client machine to run stand-alone Java applications.

Operating system 506 also includes virtual memory manager 510, device drivers 512, and operating system kernel 514. Virtual memory manager 510 simulates more physical memory than actually exists in a data processing system. This component breaks up a program into small segments, called “pages,” and brings as many pages from a storage device in to physical memory that fit into a reserved area for that program. When additional pages are required, virtual memory manager 510 makes room for these pages by swapping them to the storage device. This component keeps track of pages that have been modified so that they can be retrieved when needed again.

Device drivers 512 are programs that link the operating system to a peripheral device. Device drivers 512 understand the language and characteristics for different hardware devices. Device drivers 512 contain the precise machine language necessary to perform the functions requested by an application. A kernel is a part of an operating system that resides in memory at all times and provides the basic services. This component is the part of the operating system that is closest to the hardware and may activate the hardware directly or interface to another software layer that drives the hardware.

Virtual memory manager 510 and device drivers 512 provide access to data and physical memory 516. For example, operating system 506 may save data from physical memory 516 to storage device 518 through calls to device drivers 512. Other devices that may access physical memory 516 include basic input/output system (BIOS) 520 and processor 522.

In the illustrative embodiments, the components in operating system 506 provide an infrastructure for an undo service that may be accessed by applications such as, applications 500 and Java applications 502. This service also may be accessed directly by users through a user interface provided in applications 500. Java applications 502 make calls to undo changes or restore a previous version of data to Java virtual machine 504. This virtual machine passes the call on to operating system 506.

The undo service in these examples is accessed through API calls to API layer 508. In this example, such a call is handled by operating system kernel 514. In other words, processes for the undo service are located in operating system kernel 514. If the call is to generate a version of data, operating system kernel 514 stores data from physical memory 516 in to a data store. A data store is a permanent storage for data. A data store is often located in a disk drive. This data store may be located in storage device 518. In response to receiving a call to store a version of data, operating system kernel 514 returns a version identifier to the caller. This identifier may take various forms. The identifier may be, for example, a time stamp or a numeric value. The manner in which the version of data is generated may be made using currently available snapshot mechanisms.

Data may be restored to a prior version through a call to the undo service accessed through API layer 508. In theses examples, the call includes the version identifier for the version of data that is to be restored. Additionally, versions of data may be stored on a periodic basis or in response to an event occurring without requiring the application to make a call to initiate the storing of the version.

In addition to storing data that may be located in physical memory 516, the mechanism of the present invention also stores other information that may be needed by an application that makes a call to restore data in physical memory 516 to a prior state. This other information includes, for example, prior versions of pages stored in a swap file, the state of device drivers, and the state of hardware devices accessed by device drivers.

In these depicted examples, operation system kernel 514 makes calls to resource managers such as virtual memory manager 510 and device drivers 512 to save information needed to properly store data to a prior version. Resource managers are software control systems for computer system resources, such as, for example, hard disk drives, keyboards, memory, graphics adapters, and printer. For example, a call may be made by an application to restore a document to a prior version. This prior version also may be associated with printer settings that are different from the current printer settings. These settings may be used to restore the printer to its previous state in conjunction with restoring the document to its previous state. The mechanism of the present invention would make appropriate calls to device drivers 512 to restore the printer device driver and the printer itself to the state present at the time the prior version of the document was made. This is information that is related to the data stored in memory is referred to as being co-dependent. Data is co-dependent, as used herein, when the data requires other data to be properly used.

Turning next to FIG. 6, a diagram illustrating components used to provide an undo service is depicted in accordance with a preferred embodiment of the present invention. In these illustrative examples, these undo services are located in operating system kernel 600. More specifically, this service may be implemented as versioning subsystem 602.

When save API call 604 is received from an application, versioning subsystem 602 saves information stored in the memory managed by memory management subsystem 606 into data stack 608. In these examples, versioning subsystem 602 takes a snapshot of the memory and stores the data in data stack 608. This version of the data is associated with an index, which is returned to the caller that called save API call 604. In addition, versioning subsystem 602 makes calls to a virtual memory manager in memory manager subsystem 606 and to device drivers 610 to save other information needed to restore the data in the memory to the version stored in data stack 608. In theses examples, this other information is co-dependent information and includes, for examples, pages stored in a swap file by the virtual memory manager and device driver state information and hardware state information.

When restore API call 612 is made to operating system kernel 600, this call is handled by versioning subsystem 602 in these examples. A version identifier is identified from the call. This version identifier is employed by versioning subsystem 602 to restore a prior version of data from data stack 608 into the memory. Additionally, versioning subsystem 602 also may restore other state information, such as a state of pages, device drivers, and hardware. Versioning subsystem 602 accomplishes this restoration by making calls to the virtual memory manager and device drivers 610.

In this manner, the entire data processing system, including hardware peripherals, may be restored to a prior state. In these examples, different components within the operating system aid in managing information needed to restore the data processing system to a prior state.

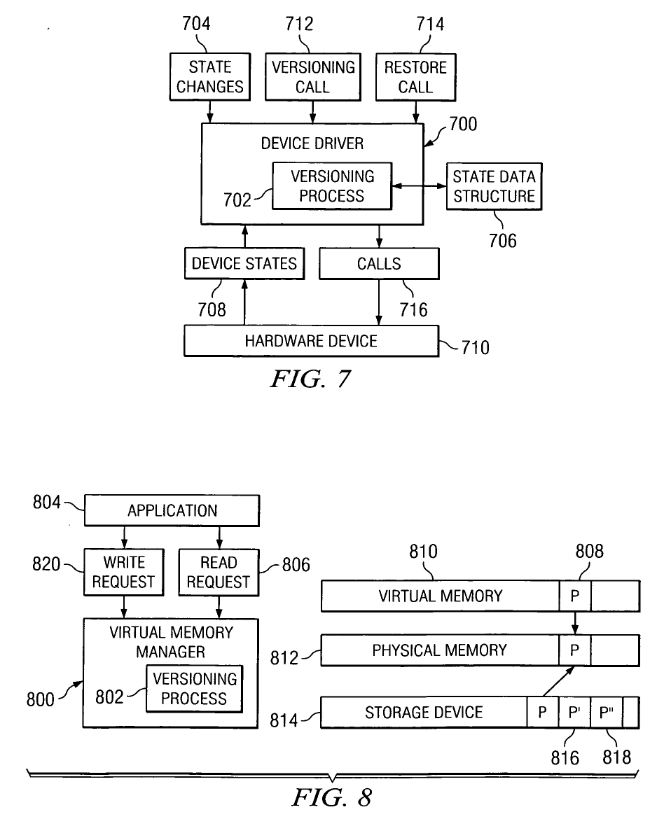

Turning next to FIG. 7, a diagram illustrating a device driver used to save state information is depicted in accordance with a preferred embodiment of the present invention. In this example, device driver 700 is an example of device driver located in device drivers 512 in FIG. 5. In this example, device driver 700 includes versioning process 702. Versioning process 702 stores state changes 704 within state data structure 706. In these examples, state data structure 706 contains state information for device driver 700. Further, versioning process 702 also stores changes in device states 708 within state data structure 706. The illustrative examples show this process being initiated in response to a call from an operating system kernel. This process also may be initiated in response to calls from other sources, such as a hardware interrupt, a soft interrupt, and a device driver interface.

State data structure 706 may be a data store located in a hard disk drive.

State changes 704 include, for example, requests to change various parameters or settings for device driver 700. For example, these parameters or settings may include paper size, downloaded fonts, landscape mode, and print qualities. Changes in device state 708 are generally identified by a hardware device generating an interrupt, such as hardware device 710. One example is a caps lock button being depressed on a keyboard. Another example of a device state is a printer in a PCL print mode. Yet another example is whether a session is present on a network card. Other state information may include whether a valid connection is present and the speed of the connection of the network card. This state information for hardware device 710 is stored in state data structure 706 to allow hardware device 710 to be placed or restored to a prior state at a later time.

In these examples, the state information from different state changes stored in state data structure 706 is used to create a version of state information. In other words, the state information contains all the information needed to return device driver 700 and/or hardware device 710 to some prior state. This version of the state information is associated with an identifier. In this manner, device driver 700 and/or hardware device 710 may be restored to a prior state.

All of the versions of data stored by versioning process 702 contain information to place device driver 700 and hardware device 710 in to some restorable state. A version identifier is associated with state information when versioning call 712 is received. In these examples, versioning call 712 is received from a versioning subsystem, such as versioning subsystem 602 in FIG. 6.

When restore call 714 is received, versioning process 702 identifies a version identifier from this call. In these examples, the call is made by versioning subsystem 602 in FIG. 6, and the version identifier takes the form of a time stamp. The data or version of data associated with the version identifier is located in state data structure 706. This information is used to place device driver 700 back to a prior state. For example, a configuration data for device driver 700 is restored to the prior state. This configuration may include various printer settings such as paper type and printing quality when hardware device 710 is a printer.

Additionally, the state information data in state data structure 706 is used to restore hardware device 710 to the prior state. For example, if hardware device 710 is a printer, and the prior state was a PCL print mode, calls 716 may be made to hardware device 710. For example, calls 716 may include a call to reset hardware device 710 to this particular print mode. If hardware device 710 takes the form of a network card, the state information may include, for example, whether a valid connection was present at that time and the speed of the connection. In this case, versioning process 702 generates calls 716 to place hardware device 710 back in to the previous state. These calls may include, for example, calls needed to set up the connection in its prior state. In the instance in which hardware device 710 is a keyboard, signals may be sent to set features such as caps lock or number lock in to the state present at the time the version was made.

Turning to FIG. 8, a diagram illustrating a virtual memory manager used to save state information is depicted in accordance with a preferred embodiment of the present invention. As illustrated, virtual memory manager 800 is part of a paged memory system. This type of memory system is one that uses sections of memory called pages, which are swapped in and out of physical memory. In this example, virtual memory manager 800 contains versioning process 802. Application 804 may send read request 806 to virtual memory manager 600 to access page P 808 in virtual memory 810. Virtual memory 810 provides a simulation to provide more memory than physically exists. As many pages as possible are placed in to physical memory 812. Other pages are stored in a swap file in a data store, which may be located in storage device 814. A swap file is a file on a permanent storage device, also called a data store. This swap file is used to hold pages that cannot be stored in a physical memory.

Normally read request 806 is a request for a page, such as page P 808 in virtual memory 810. If page P 808 is not present in physical memory 812, the page has been swapped out or placed in to a swap file in storage device 814. Page P 808 is retrieved from storage device 814 and placed in to physical memory 812 for use.

In this example, versioning process 802 checks read request 806 to determine whether an “overload” has occurred. An overload occurs if an argument, such as a version identifier or some other parameter, has been added to indicate that a different function should occur. An argument may be added to read request 806 to use a different version of the function used to retrieve pages from a swap file in a storage device, such as storage device 814. If an additional argument has been added, versioning process 802 uses the argument to identify another version of page P 808, such as page P′ 816 or page P″ 818. If one of these other versions of the page is identified by the additional argument, versioning process 802 places that identified page into physical memory 812 in place of page P 808.

A new version of a page, such as page P 808 may be generated in response to write request 820. When write request 820, containing an additional argument, is received by virtual memory manager 800, versioning process 802 stores the current version of page P 808 in storage device 814 before writing the new page in to physical memory 812. Versions of pages may be made based on different events. For example, the version may be made every time a write request occurs. Alternatively, this version may be made periodically. The version may be made before or after the write to the page occurs, depending on the particular implementation. For example, the version may be made after a change to the page occurs. If a page is initialized with content, and then the content is changed, the changed content is stored as a version. Alternatively, the version is recorded before the change. In this implementation, when current content is changed to new content, the current content is stored before the change is made. The calls to read and write different versions of pages may be made by versioning subsystem 602 in FIG. 6. These calls also may be made by applications directly, depending on the implementation. In this manner, versioning process 802 in virtual memory manager 800 allows for different versions of pages to be restored for use in restoring a data processing system to a prior state. These different versions of the pages are used in conjunction with other store and restore features described herein to provide an infrastructure for API based undo functions.

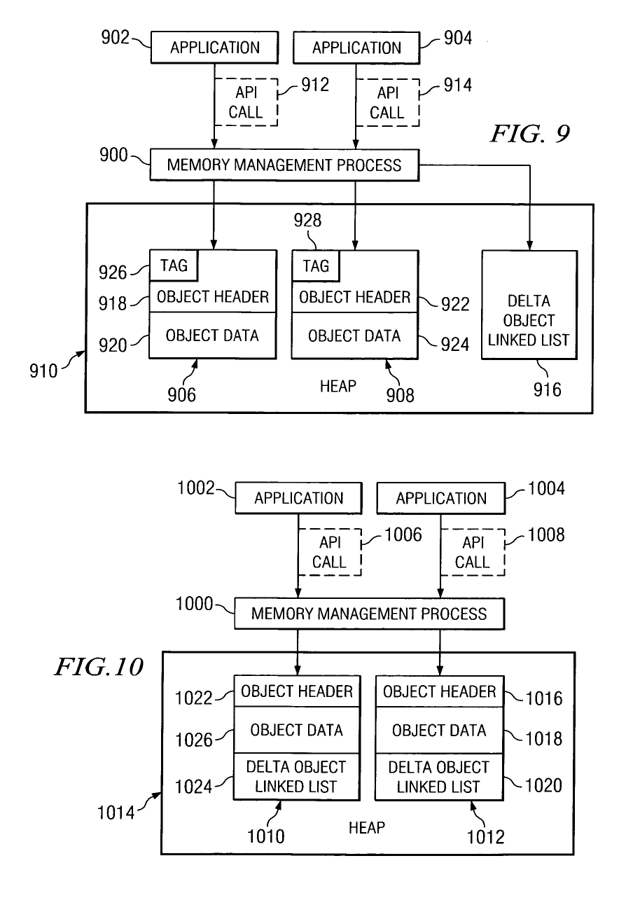

Turning now to FIG. 9, a diagram illustrating components used in data versioning and recovery is depicted in accordance with a preferred embodiment of the present invention. Memory management process 900 receives requests from applications, such as application 902 and application 904 to allocate objects, such as objects 906 and 908. Memory management process 900 may be implemented in a memory management component in a Java virtual machine, such as Java virtual machine 400 in FIG. 4.

In these examples, the requests from application 902 and application 904 take the form of application programming interface (API) call 912 and API call 914. An API is a language and message format used by an application program to communicate with the operating system. APIs are implemented by writing function calls in the program, which provide the linkage to the required subroutine for execution. If these API call include an argument or parameter indicating that delta data should be stored for restoring prior versions of an object, objects 906 and 908 are allocated in a manner to allow for versioning of the objects to occur. In other words, changes in data in these objects are stored in a manner to allow the objects to be restored to a prior version.

In these illustrative examples, this delta data is maintained using delta object linked list 916, which is a data structure located within heap 910. This list is allocated by memory management process 900. This particular data structure contains a linked list of entries that identify delta data for various objects, such as object 906 and object 908.

In this example, object 906 includes object header 918 and object data 920. Object 908 includes object header 922 and object data 924. Object data 920 and object data 924 contain the data for the object in its current state. Object header 918 includes a pointer or offset to delta object linked list 916. In a similar fashion, object header 922 also includes a pointer or offset in the delta object linked list 916.

In allocating object 906 and 908, memory management process 900 also includes an indicator or tag with object headers 918 and 922. As depicted, object header 918 contains tag 926, and object header 922 contains tag 928. These indicators or tags are used to identify objects 906 and 908 as objects for which delta data will be stored to allow restoring these objects to a prior state.

When application 902 changes an object, such as object 906, memory management process 900 creates an entry within delta object linked list 916 to store the delta data. Specifically, any changed values in object 906 are stored within delta object linked list 916 in association with the identification of object 906 and an index, such as a numerical value or a timestamp.

This change in data may be stored every time an object is changed. Alternatively, the changes may be stored only when an application changes the data through an API call that includes an additional parameter or argument that indicates that the change is to occur. An example of an API call is set_version (object reference, object version). The object reference is the identification of the object, and the object version provides an identifier. Alternatively, the object version may be excluded from the call. In this case, memory management process 900 may generate a version identifier to return to the application making the call.

In this manner, all changes to object 906 are stored within delta object linked list 916. Thus, object 906 may be returned to any prior state desired using this data structure.

If a request is received by memory management process 900 to restore one of the objects in the heap to a prior state, the process identifies the object and an index to identify the state that is desired. An example of an API call is restore_version (object reference, object version). The object reference is a pointer to the object that is to be restored. The object version is an index used to identify the version of the object that is to be restored.

This index may be, for example, a numerical value or a timestamp. If, for example, object 906 is identified in the request, the object header is used to find delta object linked list 916. The index in the request is used to identify the desired state for object 906. Based on the particular entry identified in linked list 916, the linked list may be traversed to make the appropriate changes to object 906 to return that object to its original state.

In these depicted examples, all of the delta data for all objects is stored within delta object linked list 916. The entries that apply to a particular object that may be identified through an object identifier that is found within each entry of delta object linked list 916.

In other illustrative examples, a separate linked list data structure may be used for each object. In this case, the object header provides an offset to the particular linked list data structure for that object.

Turning next to FIG. 10, a diagram illustrating components used in providing data versioning and recovery management is depicted in accordance with a preferred embodiment of the present invention. In this example, the visioning data, also referred to as delta data, is stored within the objects.

In this illustrative example, memory management process 1000 receives requests from application 1002 and application 1004 in the form of API calls 1006 and 1008 to create objects 1010 and 1012 for use by the applications. In this example, object 1010 is created for use by application 1002, and object 1012 is created for use by application 1004. Memory management process 1000 may be implemented within a virtual machine, such as Java virtual machine 400 in FIG. 4. In these examples, objects 1010 and 1012 contain delta data that allows these objects to be restored to a prior version or state.

Objects 1010 and 1012 are located in heap 1014. Object 1010 includes object header 1022, object data 1026, and delta object linked list 1022. Object header 1022 includes an offset to point to the beginning of delta object linked list 1024 in this illustrative example. Object data 1026 contains the current data for object 1010. Delta object linked list 1024 contains entries that identify all of the delta data for object 1010. In a similar fashion, object header 1016 provides an offset to the beginning of delta object linked list 1020. Object data 1018 contains the current data for object 1012. Delta object linked list 1020 contains all the delta data for changes made to object data 1018. These types of objects are created when a call to allocate an object includes an additional parameter or argument that indicates that the object should be restorable to a prior state. If this additional argument or parameter is missing, the objects allocated normally.

In this illustrative example, memory management process 1000 automatically increases the size of object 1010 in response to a request to allocate object 1010 in which the request includes an indication that that object 1010 is to store data needed to restore object 1010 to a prior version or state. This increased size includes space needed to store the delta data.

In addition to allocating these objects in response to a specific call requesting data versioning for the objects, this type of allocation for objects 1010 and 1012 may be performed automatically without requiring an application or a user to request the additional memory to store delta data. Additionally, memory management process 1000 may allocate more space for object 1010 and object 1012 as the object data and the delta data increase for these objects.

In this particular illustrative embodiment, these objects may be moved and copied such that the delta data automatically is moved or copied with the objects. In this manner, an object may be saved and reloaded at a later time with its delta data intact. In this fashion, an object may be restored to a prior state at any time without having to locate or save data objects from the heap and restore those objects separately.

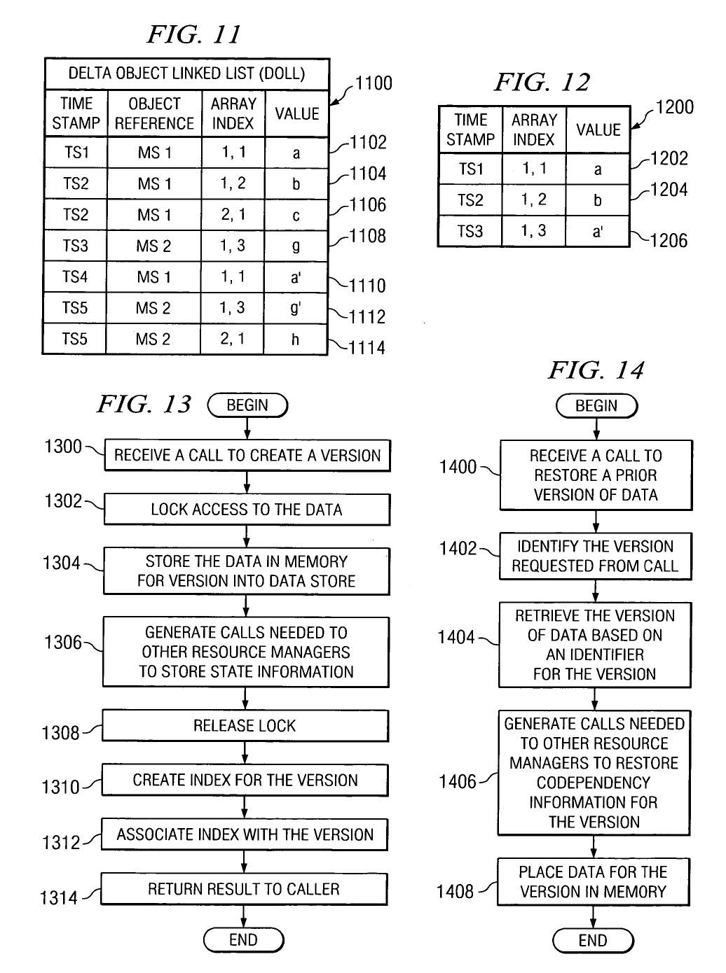

Turning now to FIG. 11, a diagram illustrating a delta object linked list is depicted in accordance with a preferred embodiment of the present invention. In the depicted example, delta object linked list 1100 is an example of delta object linked list 916 as created by memory management process 900 in FIG. 9.

In these illustrative examples, delta object linked list 1100 contains entries 1102, 1104, 1106, 1108, 1110, 1112, and 1114. As shown, each of these entries contains a time stamp, an object reference, an array index, and a value. The time stamp indicates when the entry was made. The object reference is the pointer to the object for the entry. The array index identifies the location in which data has changed, and the value indicates the change in the data at that location.

In this illustrative example, the prior state is identified through a timestamp. If the memory management subsystem receives a request identifying a particular timestamp and object, the object may be returned to that state. Entry 1114 is the most recent entry, while entry 1102 is the oldest entry. Entries 1102, 1104, 1106, and 1110 are entries for one object, MS 1. Entries 1108, 1112, and 1114 are entries for another object, MS 2. The mechanism of the present invention traverses the linked list from the most current entry to the entry identified by the timestamp. Entries for objects other than the selected object are ignored.

This type of traversal and restoration of data is provided as one manner in which an object may be restored to a prior state. Of course, any process used to return an object to a prior state using delta data may be employed in these illustrative examples.

The delta in data may be identified or calculated in a number of different ways. In these examples, the delta data may be calculated using an exclusive OR (XOR). In other words, the value of prior data may be XOR'd with the value of the current data to identify the change in the current data as compared to the prior data. The result of this function is considered the delta in the data in this example. With this delta the current data may be restored to the value of the current data. The data may be, for example, the values for data in all of the heaps managed by a memory management system. The delta in the data also may be calculated using Moving Picture Experts Group processes, such as MPEG 2. With these processes every delta is similar to a video frame with respect to normal use in processing video data. Instead, the deltas are for one or more memory segments. As with a video, in which not every pixel necessarily changes from frame to frame, not all of the data elements within a memory segment may change from one delta to another delta. Compression algorithms, similar to MPEG2, can be employed which minimize the amount of memory required to store the necessary information, or delta, to restore the memory segments to prior values.

Turning next to FIG. 12, a diagram of a delta object linked list is depicted in accordance with a preferred embodiment of the present invention. Delta object linked list 1200 is an example a list that is found in an object. In particular, delta object link list may be implemented as delta object linked list 1020 in object 1012 in FIG. 10.

As shown, delta object linked list 1200 includes entries 1202, 1204, and 1206. Each entry includes a time stamp, an array index, and a value. An object reference is not included in this list as with delta object linked list 1100 in FIG. 11 because this list is contained within the object for which changes in data, delta data, are stored.

Although FIGS. 11 and 12 specify types of changes in data in which an array is used to identify where changes in data has occurred, any type of system may be used to identify changes in data.

Additionally, the mechanism of the present invention allows for portions of code to be marked in which objects on the marked portions are tracked for changes. This mechanism is implemented in a memory management process, such as memory management process 1000 in FIG. 10.

Turning next to FIG. 13, a flowchart of a process for storing a version of data is depicted in accordance with a preferred embodiment of the present invention. The process illustrated in FIG. 13 may be implemented in an operating system kernel, such as operating system kernel 600 in FIG. 6. In particular, this process may be implemented in a versioning subsystem, such as versioning subsystem 602 in FIG. 6.

The process begins by receiving a call to create a version (step 1300). In response to receiving the call, the access to the data is locked to prevent changes to the data until the version or snapshot of the data is made (step 1302). The data in the memory is stored in a data store (step 1304). Thereafter, calls are made to resource managers to store state information (step 1306). This state information is information that is needed to return the entire data processing system to a particular state. This information may include the state of hardware devices such as, adapters or peripherals. The adapters may be, for example, a graphics adapter or a network adapter. Peripherals include, for example, a printer, a display device, a keyboard, and a mouse.

After the other resource managers have stored state information, the lock on the data is released (step 1308). An index in the form of a version identifier is created for the version of data placed in to the data store (step 1310). This index may be, for example, a time stamp or a numerical value. The index is then associated with the version of data (step 1312). The result is then returned to the caller (step 1314) with the process terminating thereafter.

Turning now to FIG. 14, a flowchart of a process for restoring a prior version of data is depicted in accordance with a preferred embodiment of the present invention. The process illustrated in FIG. 14 may be implemented in an operating system kernel, such as operating system kernel 600 in FIG. 6. In particular, this process may be implemented in a versioning subsystem, such as versioning subsystem 602 in FIG. 6.

The process begins by receiving a call to restore a prior version of data (step 1400). Next, the version of data requested from the call is identified (step 1402). The version of data is retrieved from a data store based on the identifier (step 1404). Calls are generated to other resource managers to restore co-dependant information for the version (step 1406). The co-dependant information includes, for example, restoring virtual memory and hardware to a prior state. The data retrieved from the data store for the version is placed in to memory (step 1408) with the process terminating thereafter.

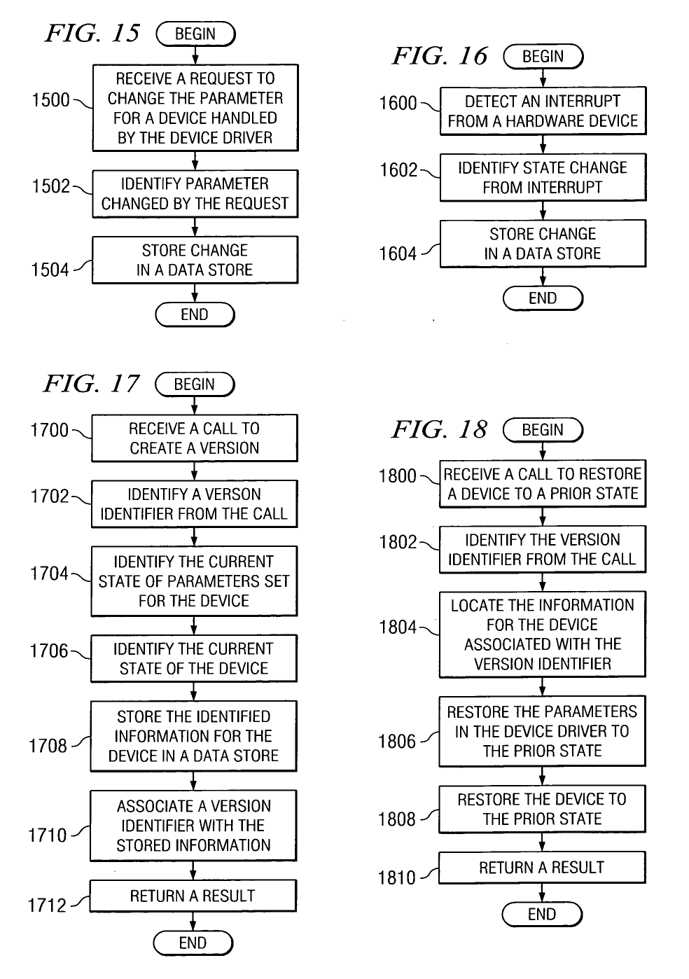

With reference next to FIG. 15, a flowchart of a process in a device driver for saving state information is depicted in accordance with a preferred embodiment of the present invention. The process illustrated in FIG. 15 may be implemented in an operating system, such as operating system 506 in FIG. 5. In particular, this process may be implemented in a versioning process, such as versioning process 702 in device driver 700 in FIG. 7.

The process begins by receiving a request to change the parameter for a device handled by the device driver (step 1500). This parameter may be, for example, a color or font type to be displayed by a graphics adapter. The device driver then identifies the parameter changed by the request (step 1502). Once the device driver has identified the parameter changed by the request, the change is then stored in a data store (step 1504) with the process terminating thereafter.

With reference to FIG. 16, a flowchart of a process in a device driver for saving state information is depicted in accordance with a preferred embodiment of the present invention. The process illustrated in FIG. 16 may be implemented in an operating system, such as operating system 506 in FIG. 5. In particular, this process may be implemented in a versioning process, such as versioning process 702 in FIG. 7.

The process begins by detecting an interrupt from a hardware device handled by the device driver (step 1600). Next, the state change in the hardware device is identified from the interrupt (step 1602). The state change may be identified from the interrupt identifier received with the interrupt. This change is stored in a data store (step 1604) with the process terminating thereafter.

With reference next to FIG. 17, a flowchart of a process in a device driver for saving state information is depicted in accordance with a preferred embodiment of the present invention. The process illustrated in FIG. 17 may be implemented in an operating system, such as operating system 506 in FIG. 5. In particular, this process may be implemented in a versioning process, such as versioning process 702 in FIG. 7.

The process begins by receiving a call to create a version (step 1700). In these examples, the call is received from a process, such as versioning subsystem 602 in FIG. 6. This call is received as part of a process for creating a version of data or a snapshot for the data processing system. A version identifier is then identified from the call (step 1702). The versioning subsystem includes a version identifier to identify co-dependant information stored by the device driver.

The current state of the parameters set for the device is then identified (step 1704) followed by identifying the current state of the device (step 1706). The state information in steps 1704 and 1706 are identified in a data store. This information is generated using processes described in FIGS. 15 and 16.

The identified information for the device is then stored in a data store (step 1708). A version identifier is then associated with the stored information (step 1710). A result is returned (step 1712) thus terminating the process. This result is returned to the caller of the process such as a versioning subsystem. In this manner, a device driver may generate versioning information for use in restoring portions of a data processing system to a prior state. In these examples, these portions include the device driver itself and the hardware device or devices managed by the device driver.

Turning to FIG. 18, a flowchart of a process in a device driver for restoring state information is depicted in accordance with a preferred embodiment of the present invention. The process illustrated in FIG. 18 may be implemented in an operating system, such as operating system 506 in FIG. 5. In particular, this process may be implemented in a versioning process, such as versioning process 702 in FIG. 7.

The process begins by receiving a call to restore a device to a prior state (step 1800). The call is received from a caller, such as versioning subsystem 602 in FIG. 6. The version identifier is then identified from the call (step 1802). This version identifier is placed in the call by the caller to locate co-dependant information needed to restore the data processing system to a prior state. The information for the device associated with the version identifier is then located (step 1804). In these examples, this information is found in a data state, such as a hard disk drive. The parameters in the device driver are restored to the prior state (step 1806). The device is restored to the prior state (step 1808). Step 1808 includes making calls to the hardware device to restore the device to the prior state. In some cases, this process may include resetting or restarting the device and then sending calls to set the device to the prior state.

A result is then returned (step 1810) with the process terminating thereafter. This result is returned to the caller. In some cases, a failure may be returned if the hardware device cannot be reset or restored to the prior state.

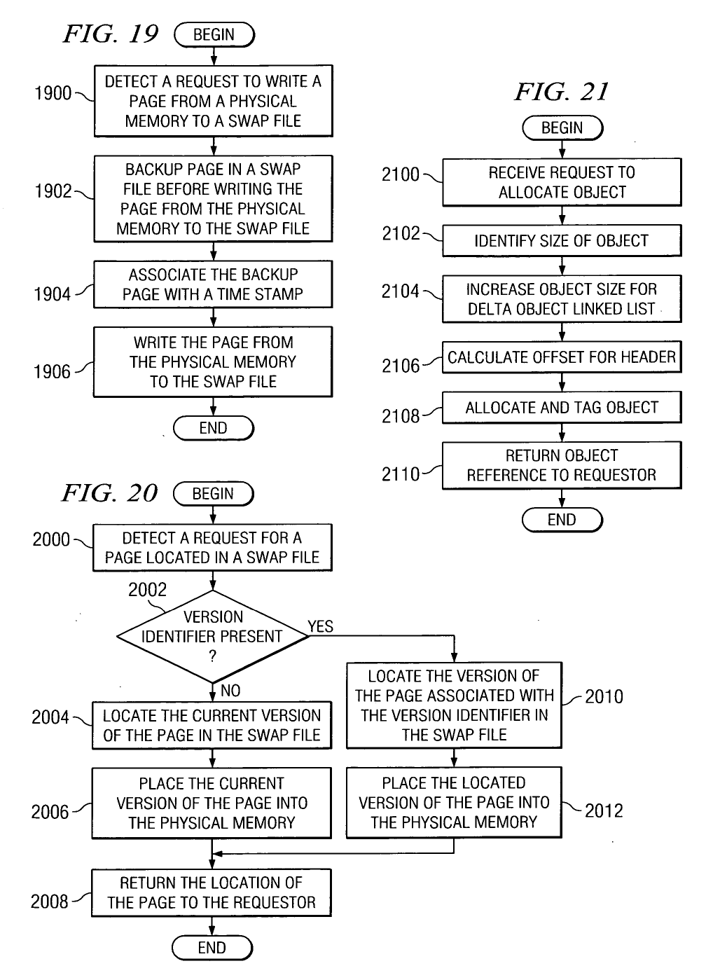

Turning to FIG. 19, a flowchart of a process in a virtual memory manager for storing versions of pages is depicted in accordance with a preferred embodiment of the present invention. The process illustrated in FIG. 19 may be implemented in an operating system, such as operating system 506 in FIG. 5. In particular, this process may be implemented in a virtual memory manager, such as virtual memory manager 800 in FIG. 8.

The process begins by detecting a request to write a page from a physical memory to a swap file (step 1900). This request occurs when not enough room is present in the physical memory. The page is then backed up in the swap file before writing the page from physical memory to the swap file (step 1902). In step 1902, a copy of the page is made in the swap file to form a backup page. Depending on the particular implementation, this backup page may be stored in another file or location. The backup page is associated with the time stamp (step 1904). The current page in physical memory is then written from the memory to the swap file (step 1906) with the process terminating thereafter.

Turning to FIG. 20, a flowchart of a process in a virtual memory manager for retrieving pages from a swap file is depicted in accordance with a preferred embodiment of the present invention. The process illustrated in FIG. 20 may be implemented in an operating system, such as operating system 506 in FIG. 5. In particular, this process may be implemented in a virtual memory manager, such as virtual memory manager 800 in FIG. 8.

The process begins by detecting a request for a page located in a swap file (step 2000). This request occurs when an application requests a page in virtual memory that is not actually present in the physical memory. In response to detecting this request, a determination is made as to whether a version identifier is present in the request (step 2002). In this example, the version identifier is considered an additional argument or parameter that may be used to initiate a different version of a function. With respect to the virtual memory manager, this different version of the function allows for a prior version of a page to be placed in the physical memory, rather than the current version.

If the version identifier is not present, the current version of the page in the swap file is located (step 2004). This current version of the page is then placed in to physical memory (step 2006). The location of this page is then returned to the requester (step 2008) with the process terminating thereafter.

With reference again to step 2002, if a version identifier is present, the version of the page associated with the version identifier is located in the swap file (step 2010). This located version of the page is then placed in to the physical memory (step 2012) with the process then proceeding to step 2008 as described above.

Turning now to FIG. 21, a flowchart of a process for allocating objects is depicted in accordance with a preferred embodiment of the present invention. The process illustrated in FIG. 21 may be implemented in a memory management process, such as memory management process 900 in FIG. 9.

The process begins by receiving a request to allocate an object (step 2100). In these examples, the request is received from an application, such as application 902 in FIG. 9, in the form of an API call to the java virtual machine. In response, the size of the object is identified (step 2102). Several options exist as to where, in memory, to place the delta object linked list. The consideration of which option to choose is based upon tradeoffs in performance and or memory usage. In a preferred, performance optimized embodiment, the delta object linked list is co-resident in memory with the data element for which it contains delta information. In this case, at object creation, memory is allocated sufficient to contain both the data element and an estimated size for the delta object linked list. In these examples, the estimated size being calculated primarily by the number of deltas desired to be retained. The object size for the object is increased to include the delta object linked list (step 2104).

Next, an offset is calculated and stored in the object header (step 2106). This offset is used by the memory management subsystem to point to the delta object linked list. The object is then allocated and tagged (step 2108). The object is tagged by including a tag or indicator within the object. This tag or indicator is used to identify the object as one in which delta data is stored for versioning. An object reference is then returned to the requester (step 2110). This object reference is used by the requester to write or read the object.

At this point, the requestor may access the allocated object. In these illustrative examples, step 2104 may be an optional step depending on the particular implementation. In the instance in which the delta object linked list is allocated as a separate data structure from the object, this step may be skipped.

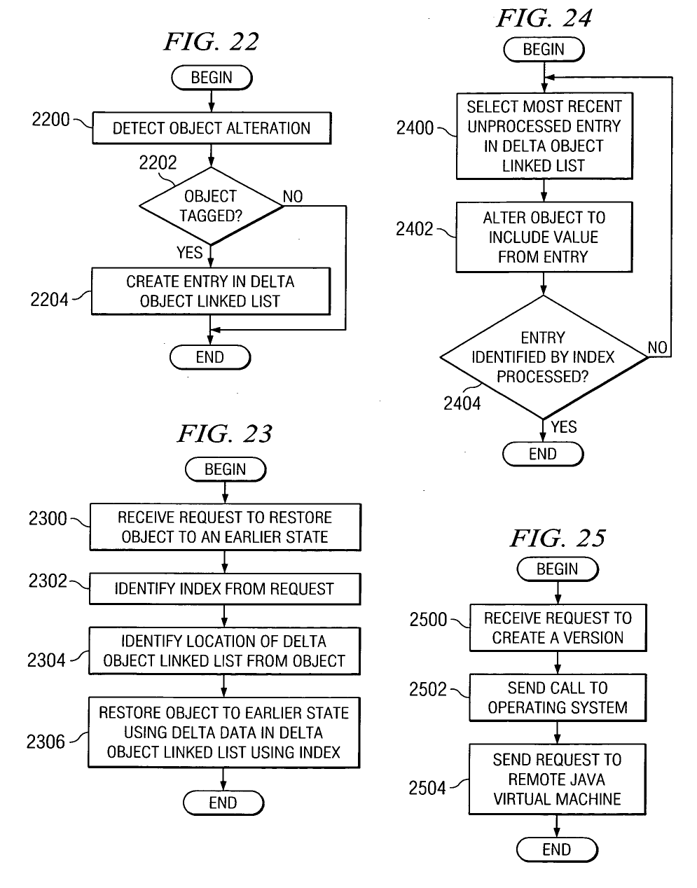

Turning now to FIG. 22, a flowchart of a process for storing delta data is depicted in accordance with a preferred embodiment of the present invention. The process illustrated in FIG. 22 may be implemented in a memory management process, such as memory management process 900 in FIG. 9.

The process begins by detecting an alteration of the data in the object (step 2200). This step may occur in different ways; for example, when the memory management process receives a request to change data in an object. When that change is processed, a determination is made as to whether the object is tagged (step 2202). The tag is used to indicate whether the object is set up such that changes in data can be stored for the object. If the object is tagged, an entry is created in the delta object linked list (step 2204) with the process terminating thereafter. Otherwise the process terminates without storing the delta data. The linked list in step 2204 may be a combined linked list for all objects being managed. Alternatively, the linked list may be one that was created within the object when the object was allocated or as a separate linked list associated with the object.

Turning now to FIG. 23, a flowchart of a process for returning an object to an earlier state is depicted in accordance with a preferred embodiment of the present invention. In this illustrative example, the process in FIG. 23 may be implemented in a memory management process, such as memory management process 900 in FIG. 9 or memory management process 1000 in FIG. 10.

The process begins by receiving a request to restore an object to an earlier state (step 2300). This request may be received from an application or a user input. Additionally, the request may be received from another process, such as an operating system or Java virtual machine process requiring the object to be returned to some other state. An index and an object identifier are identified from the request (step 2302). The location of the delta object linked list is identified from the object (step 2304). In step 2304, the location of the delta object linked list is identified using the offset from the object header. Thereafter, the object is restored to the earlier state using the delta data in the delta object linked list using the index (step 2306) with the process terminating thereafter.

Turning now to FIG. 24, a flowchart of a process for restoring an object to an earlier state is depicted in accordance with a preferred embodiment of the present invention. The process illustrated in FIG. 24 is a more detailed description of step 2306 in FIG. 23.

The process begins by selecting a most recent unprocessed entry in the delta object linked list (step 2400). The object is then altered to include the value from the entry (step 2402). Next, a determination is made as to whether an entry identified by the index has been processed (step 2404). This step determines whether the particular index, such as a timestamp for the object, has been processed. If this entry has been processed, the object has then been returned to the desired state with the process terminating thereafter.

Otherwise, the process returns to step 2400 to select the next most recent unprocessed entry in the delta object linked list. In the instance in which the linked list includes entries for other object, a determination may be included to determine whether the object identifier is for the object that is being restored.

Turning to FIG. 25, a flowchart of creating a version of data on a remote data processing system is depicted in accordance with a preferred embodiment of the present invention. The process illustrated in FIG. 25 may be implemented in a Java virtual machine, such as Java virtual machine 400 in FIG. 4. This process may be used to store versioning data for a particular session between two applications on two different Java virtual machines.

The process begins by receiving a request to create a version of data (step 2500). This request may be received from an application running in a Java virtual machine. For example, a user may wish to save state information or data at a particular point in a session, such as a portion of a transaction with a remote application or before sending a request to store or change data on a remote data processing system. The request also may be generated periodically depending on the implementation.

A call is sent to an operating system (step 2502). In this example, the call is made through an API layer, such as API layer 508 in FIG. 5. This call is processed by a versioning subsystem, such as versioning subsystem 602 Located in operating system kernel 600 in FIG. 6. This call results in the saving of data by the different components in the operating system, such as Virtual memory manager 510, device driver 512, and operating system kernel 514. Further, additional granularity in versioning of data may occur by saving data for a particular application or object in the Java virtual machine. In this instance, a memory management process such as memory management process 900 in FIG. 9 may handle the API call to save data for one or more objects managed in the Java virtual machine. More specifically, data relating to the session may be stored in creating a version. This data may include, for example, information about the connection, objects created for the session in the Java virtual machine, and a state of hardware in the data processing system.

Additionally, a request to save data or state information is sent a remote Java virtual machine (step 2504) with the process terminating thereafter. In this example, the request is processed by the remote Java virtual machine in the same manner as described above in steps 2500 and 2502. Step 2504 is used to cause the remote Java virtual machine to initiate a process on the remote data processing system to save a version of data in a manner in which the remote data processing system may be returned to a prior state. Also, a finer granularity of versioning may occur in which the remote Java virtual machine, a particular application on the remote Java virtual machine, or a particular object in the Java virtual machine may be returned to a prior state without affecting other components in the remote data processing system. In these examples, the state information is saved for a particular session between two Java virtual machines.

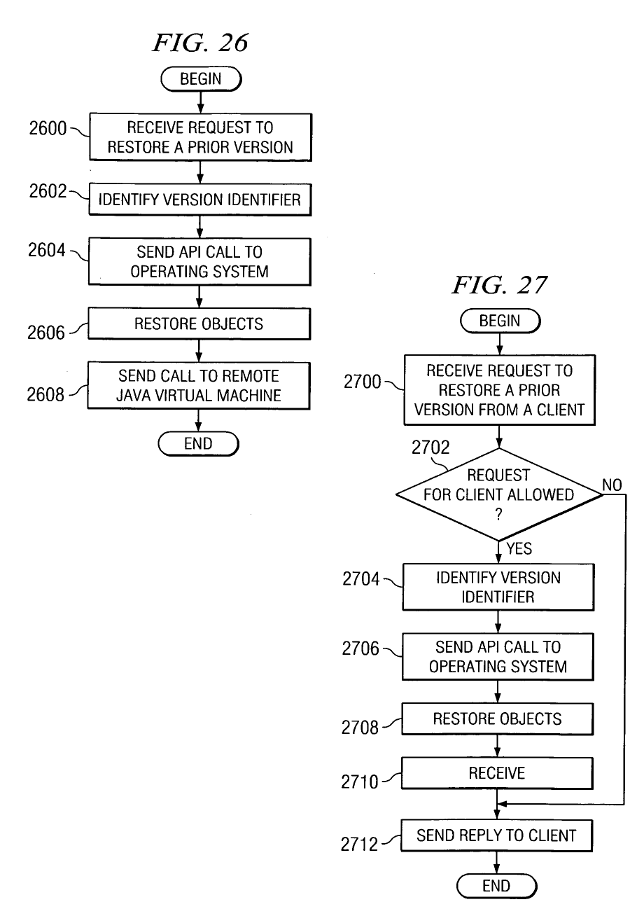

Turning to FIG. 26, a flowchart of a process for restoring data to a prior state is depicted in accordance with a preferred embodiment of the present invention. The process illustrated in FIG. 26 may be implemented in a Java virtual machine, such as Java virtual machine 400 in FIG. 4. In these examples, the data restored is the data needed for a particular version or prior state of a session between two Java virtual machines.

The process begins by receiving a request to restore a prior version (step 2600). In the illustrative embodiment, the request may be received from an application executing in a Java virtual machine, such as a browser. The version identifier is then identified from the request (step 2602).

The process then sends an API call to the operating system (step 2604). Step 2604 may be implemented using processes, such as those described in FIGS. 14, 18, and 20. The call includes the version identifier. The Java virtual machine restores one or more objects managed by the Java virtual machine to a prior state based on the version identifier (step 2606). Step 2606 may be performed using processes described in FIGS. 23 and 24 above. Next, the call is sent to a remote Java virtual machine (step 2608), thus ending the process. The call made to remote Java virtual machine also includes the same version identifier. This call is performed to place the remote Java virtual machine in the same state as the local Java virtual machine.

Turning now to FIG. 27, a flowchart of a process to restore data to a prior version is depicted in accordance with a preferred embodiment of the present invention. The process illustrated in FIG. 27 may be implemented in a Java virtual machine, such as Java virtual machine 404 in FIG. 4. In these examples, the data restored is the data needed for a particular version or prior state of a session between two Java virtual machines.

The process begins by receiving a request to restore a prior version from a client (step 2700). In step 2700, the client is a Java virtual machine located in a remote data processing system. In these examples, the request is to restore a session to a prior state. This session, in these examples, is a session between two applications in two different Java virtual machines.

A determination is made as to whether the request for a client is allowed (step 2702). In some cases, this type of request may be ignored or prohibited. For example, a transaction for the sale of goods may be cancelable. In that case, the request is allowed. In other cases, a client may not be allowed to return a session to a prior state. For example, if the session is for a game, the request may be prohibited. Further, some clients may be allowed to restore prior versions of data while other clients may not be allowed this type of privilege. If the client request is allowed, the process identifies the version identifier from the call (step 2704).

An API call is made to the operating system to change the version of data (step 2706). Step 2706 may be implemented using processes, such as those described in FIGS. 14, 18, and 20. The call includes the version identifier. Next, the Java virtual machine restores one or more objects managed by the Java virtual machine to a prior state based on the version identifier (step 2708). Step 2768 may be performed using processes described in FIGS. 23 and 24 above.

A result of the changes is received (step 2710). This result is sent in a reply to the client (step 2712) with the process terminating thereafter. The process also proceeds to step 2712 to send a reply to the client indicating that the request is not allowed if the determination in step 2702 is that such a request is prohibited.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the illustrative examples are described with respect to Java virtual machines, the present invention may be applied to any type of virtual machine. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing versioning data for a prior state between a first virtual machine and a second virtual machine on a remote data processing system, the method comprising:
storing versioning information in the data processing system in response to a first request to generate a version in the first virtual machine; and
sending a second request to the second virtual machine for the second virtual machine to generate a corresponding version in response to the request to generate a version in the first virtual machine, wherein the version and the corresponding version are used to restore the first virtual machine and the second virtual machine to the prior state.

2. The method of claim 1 further comprising:
responsive to receiving a first subsequent request in the first virtual machine to restore the prior state, restoring the prior state in the first virtual machine using the version; and
sending a second subsequent request to the second virtual machine, wherein the second subsequent request requests restoring the prior state for the second virtual machine using the corresponding version.

3. The method of claim 1, wherein the second virtual machine selectively restores the prior state in the second virtual machine using the corresponding version based on a policy.

4. The method of claim 3, wherein the policy defines users for which the second subsequent request will be processed.

5. The method of claim 1, wherein the prior state is for a session between a first application in the first virtual machine and a second application in the second virtual machine.

6. The method of claim 1, wherein the first application is a client application and wherein the second application is a server application.

7. The method of claim 1, wherein the version includes data in memory managed by the first virtual machine and connection information for a connection between the first virtual machine and the second virtual machine.

8. The method of claim 7, wherein the corresponding version includes data in memory managed by the second virtual machine and connection information for a connection between the first virtual machine and the second virtual machine.

9. The method of claim 1, wherein the first request and the second request are application programming interface calls.

10. The method of claim 1, wherein the first virtual machine and the second virtual machine are Java virtual machines.

11. The method of claim 1, wherein the version and the corresponding version are associated with a version identifier.

12. A method in a data processing system for managing versioning data for a prior state between a first virtual machine and a second virtual machine on a remote data processing system, the method comprising:
receiving a request to store versioning information in the data processing system from the second virtual machine on the remote data processing system; and
storing a version containing the versioning information for use in restoring the first virtual machine to the prior state, wherein the version corresponds to another version generated by the first virtual machine for the prior state.

13. The method of claim 12 further comprising:
responsive to receiving a subsequent request in the first virtual machine to restore the prior state, selectively restoring the prior state in the first virtual machine using the version.

14. A computer program product in a computer readable medium for managing versioning data for a prior state between a first virtual machine on a data processing system and a second virtual machine on a remote data processing system, the computer program product comprising:
first instructions for storing versioning information in the data processing system in response to a first request to generate a version in the first virtual machine; and
second instructions for sending a second request to the second virtual machine for the second virtual machine to generate a corresponding version in response to the request to generate a version in the first virtual machine, wherein the version and the corresponding version are used to restore the first virtual machine and the second virtual machine to the prior state.

15. The computer program product of claim 14 further comprising:
third instructions, responsive to receiving a first subsequent request in the first virtual machine to restore the prior state, for restoring the prior state in the first virtual machine using the version; and
fourth instructions for sending a second subsequent request to the second virtual machine, wherein the second subsequent request requests restoring the prior state for the second virtual machine using the corresponding version.

16. The computer program product of claim 14, wherein the second virtual machine selectively restores the prior state in the second virtual machine using the corresponding version based on a policy.

17. The computer program product of claim 16, wherein the policy defines users for which the second subsequent request will be processed.

18. The computer program product of claim 14, wherein the prior state is for a session between a first application in the first virtual machine and a second application in the second virtual machine.

19. The computer program product of claim 14, wherein the first application is a client application and wherein the second application is a server application.

20. The computer program product of claim 14, wherein the version includes data in memory managed by the first virtual machine and connection information for a connection between the first virtual machine and the second virtual machine.

21. The computer program product of claim 20, wherein the corresponding version includes data in memory managed by the second virtual machine and connection information for a connection between the first virtual machine and the second virtual machine.

22. The computer program product of claim 14, wherein the first request and the second request are application programming interface calls.

23. The computer program product of claim 14, wherein the first virtual machine and the second virtual machine are Java virtual machines.

24. The computer program product of claim 14, wherein the version and the corresponding version are associated with a version identifier.

25. A computer program product in a computer readable medium for managing versioning data for a prior state between a first virtual machine in a data processing system and a second virtual machine on a remote data processing system, the computer program product comprising:
first instructions for receiving a request to store versioning information in the data processing system from the second virtual machine on the remote data processing system; and
second instructions for storing a version for use in restoring the first virtual machine to the prior state, wherein the version corresponds to another version generated by the first virtual machine for the prior state.

26. The computer program product of claim 25 further comprising:
third instructions, responsive to receiving a subsequent request in the first virtual machine to restore the prior state, for selectively restoring the prior state using the version.

27. A data processing system for managing versioning data for a prior state between a first virtual machine and a second virtual machine on a remote data processing system, the data processing system comprising:
storing means for storing versioning information in the data processing system in response to a first request to generate a version in the first virtual machine; and
sending means for sending a second request to the second virtual machine for the second virtual machine to generate a corresponding version in response to the request to generate a version in the first virtual machine, wherein the version and the corresponding version are used to restore the first virtual machine and the second virtual machine to the prior state.

28. The data processing system of claim 27 wherein the sending means is a first sending means and further comprising:
restoring means, responsive to receiving a first subsequent request in the first virtual machine to restore the prior state, for restoring the prior state in the first virtual machine using the version; and
second sending means for sending a second subsequent request to the second virtual machine, wherein the second subsequent request requests restoring the prior state for the second virtual machine using the corresponding version.

29. The data processing system of claim 27, wherein the second virtual machine selectively restores the prior state in the second virtual machine using the corresponding version based on a policy.

30. The data processing system of claim 29, wherein the policy defines users for which the second subsequent request will be processed.

31. The data processing system of claim 27, wherein the prior state is for a session between a first application in the first virtual machine and a second application in the second virtual machine.

32. A data processing system for managing versioning data for a prior state between a first virtual machine and a second virtual machine on a remote data processing system, the data processing system comprising:
receiving means for receiving a request to store versioning information in the data processing system from the second virtual machine on the remote data processing system; and
storing means for storing a version for use in restoring the first virtual machine to the prior state, wherein the version corresponds to another version generated by the first virtual machine for the prior state.

33. The data processing system of claim 32 further comprising:
restoring means, responsive to receiving a subsequent request in the first virtual machine to restore the prior state, for selectively restoring the prior state using the version.

34. A data processing system comprising:
a bus;
a communications unit connected to the bus;
a memory connected to the bus, wherein the memory includes a set of instructions; and
a processor unit connected to the bus, wherein the processor unit executes the set of instructions to store versioning information in the data processing system in response to a first request to generate a version in the first virtual machine; and send a second request to the second virtual machine for the second virtual machine to generate a corresponding version in response to the request to generate a version in the first virtual machine, wherein the version and the corresponding version are used to restore the first virtual machine and the second virtual machine to the prior state.
